(19) United States
(12) Patent Application Publication
(10) Pub. No.: US 2006/0064181 A1
(43) Pub. Date: Mar. 23, 2006

(54) Controlled-object model generation method program thereof and control parameter adjustment method and program thereof

(76) Inventor: Seiji Kato, Tokyo (JP)

Correspondence Address: STAAS & HALSEY LLP, SUITE 700, 1201 NEW YORK AVENUE, N.W., WASHINGTON, DC, 20005, US

(21) Appl. No.: 10/519,488

(22) PCT Filed: Jul. 1, 2003
(86) PCT No.: PCT/JP03/08336

§ 371 Date: Dec. 30, 2004

(30) Foreign Application Priority Data
Jul. 2, 2002 (JP) 2002-192815

(51) Int. Cl. G05B 13/02

(52) U.S. Cl. 700/42; 700/31; 700/30; 700/28

(57) ABSTRACT

Time series data of manipulated variables given to a controlled object and time series data of controlled variables outputted based thereon are acquired. Then, time series data of values is acquired which is outputted from a transfer function assumed in advance when the acquired time series data of manipulated variables is inputted to the transfer function. By identifying one or more parameters of the transfer function so that an error between the time series data of output values and the acquired time series data of controlled variables corresponding thereto or a value derived from the error becomes optimum, a model of the controlled object is generated.

### CROSS-REFERENCE TO RELATED APPLICATIONS

This is a Continuation Application of a PCT Application Ser. No. PCT/JP03/08336 filed on Jul. 1, 2003 in Japan.

### BACKGROUND OF THE INVENTION

1. Field of the Invention

This invention relates to controlled-object model generation method and a program therefor, and a control parameter adjustment method and a program therefor, and more particularly to a controlled-object model generation method for generating a model of a controlled object, a controlled-object model generation program used for realization of the controlled-object model generation method, a control parameter adjustment method for adjusting control parameters of a controller with the use of a controlled-object model generated by the controlled-object model generation method, and a control parameter adjustment program used for realization of the control parameter adjustment method.

2. Description of the Related Art

When a controller, such as a temperature controller, for controlling a process to be controlled is implemented, it is necessary to adjust control parameters of the controller such as PID to be appropriate ones.

Conventionally, when control parameters of a controller are adjusted, a method is adopted in which a controlled object is actually controlled with the controller. In the method, a worker tries to adjust the control parameters again and again utilizing his experience and know-how. Then, the worker acquires variation of controlled variables which the controlled object outputs in response to manipulated variables given by the controller, and compares acquired variation of controlled variables with a desired controlled variable. The worker repeats the acquisition and comparison to determine optimum control parameters.

However, the conventional technique has a problem that it may take several hours to acquire a control variable for some controlled objects, and a large amount of labor and adjustment cost is required for adjustment of control parameters.

To solve the problem, it is conceivable to use a method in which a controlled-object model is created and control parameters of a controller are determined through simulation and set on the controller.

Since there has been proposed an method for modeling a controlled object, it is possible to use a method in which a model of a controlled object is created with the use of the method and control parameters of a controller are determined through simulation and set on the controller.

However, the method for modeling a controlled object which has been tried is based on a linear algebra theory in which a successive least squares method and the like are utilized. It is an effective method when strict modeling including search for the order of a controlled object is intended, but it is not an method everybody can use.

As described above, according to the conventional technique, it is only a worker who is familiar with adjustment of control parameters and the method for modeling a controlled object to be able to adjust control parameters of a controller. And, even such a worker cannot easily adjust control parameters of a controller.

### SUMMARY OF THE INVENTION

The present invention has been made in consideration of such circumstances, and it is an object of the present invention to provide a controlled-object model generation method which enables a control variable outputted by a controlled object to be immediately acquired by enabling automatic generation of a model of the controlled object.

It is another object of the present invention to provide a controlled-object model generation program used for realization of the controlled-object model generation method described above.

It is still another object of the present invention to provide a new control parameter adjustment method which enables a worker who is not familiar with adjustment of control parameters to easily adjust control parameters of a controller by being able to immediately know the control state caused when a control parameter is changed due to the controlled-object model generation method described above.

It is further object of the present invention to provide a control parameter adjustment program used for realization of the control parameter adjustment method described above.

To achieve this object, a control parameter adjustment method of the present invention first generates a model of a controlled object by a controlled-object model generation method of the present invention and then adjusts control parameters of a controller using the generated controlled-object model.

The controlled-object model generation method of the present invention is prepared to realize the control parameter adjustment method of the present invention. The method comprises the steps of acquiring time series data of manipulated variables given to a controlled object and time series data of controlled variables outputted by the controlled object in response thereto; and generating a model of the controlled object by acquiring time series data of values which is outputted from a transfer function assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum.

In addition to the above feature, the controlled-object model generation method of the present invention has features to assume a plurality of transfer functions, to regard each of the plurality of transfer functions as processing object, and to identify parameters of the transfer function which is the processing object. And, the method of the present invention further comprise a step of selecting, from the plurality of transfer functions having the identified parameters, the optimum one as a model of a controlled object based on the error acquired when the identification is completed (or the value derived from the error).

The controlled-object model generation program of the present invention is a computer program to realize each step of any of the controlled-object model methods described above. The computer program can be recorded to a recording medium such as a semiconductor memory and provided.

In the controlled-object model generation method having features as described above, a certain transfer function (with one or more parameters) is assumed as a mathematical model of a controlled-object model. Then, a controlled-object model (with transfer characteristic of PV/MV) is generated by identifying parameters of the transfer function by an optimization method such as Powell's Method and by using time series data of manipulated variables (MV) given to a controlled object and time series data of controlled variables (PV) outputted from the controlled object in response thereto.

In most cases, transfer characteristic of a controlled-object model can be considered to be approximated by a transfer function having a transfer characteristic of “primary delay+dead time”. For some controlled-object models, however, it may be more appropriate to approximate the transfer characteristic with a transfer function having a transfer characteristic of “secondary delay+dead time”. Alternatively, it may be more appropriate to approximate the transfer characteristic with a transfer function having a transfer characteristic of “integral+primary delay+dead time”.

Accordingly, taking into consideration of such cases in the controlled-object model generation method of the present invention, a plurality of transfer functions are assumed, each of the plurality of transfer functions is regarded as processing object, and parameters of the transfer function are identified. Then, from the plurality of transfer functions having the identified parameters, an optimum one is selected as a model of a controlled object based on an error which is acquired when the identification is completed (or a value derived from the error).

In this way, according to controlled-object model generation method of the present invention, it is possible without any specialized consideration or works being required to automatically generate a model of a controlled object, only acquiring time series data of manipulated variables given to the controlled object and time series data of controlled variables outputted from the controlled object in response thereto.

According to the controlled-object model generation method of the present invention, it is possible to automatically generate a controlled-object model realizing higher-accuracy modeling by assuming a plurality of transfer functions.

It is a main purpose of controlled-object modeling required in the field of process control to enable appropriate adjustment of control parameters of a control algorithm (a mathematical model of a control method) implemented on a controller. In adjustment of the control parameters at the scene, an adjustment method with which everyone can easily perform adjustment and an almost favorable control result can be obtained is more desirable than a specialized adjustment method using strict modeling. The controlled-object model generation method of the present invention provides an method for modeling a controlled object capable of responding to such expectation.

The control parameter adjustment method of the present invention comprises the steps of: generating a model of a controlled object according to any of the above described controlled-object model generation methods of the present invention; in order to adjust a control algorithm of the controller, adjusting control parameters of the control algorithm; and creating and outputting data showing relationship among a desired controlled variable, a manipulated variable and a controlled variable by simulating the state when the controller with the adjusted control parameters controls the controlled object with the use of the generated controlled-object model and the control algorithm of the controller with the adjusted control parameters.

The control parameter adjustment program of the present invention is a computer program for realizing each processing steps of any of the controlled-object model generation methods described above. The computer program can be recorded to a recording medium such as a semiconductor memory and provided.

In the control parameter adjustment method of the present invention having feature as described above, a controlled-object model is created according to the controlled-object model generation method of the present invention, and then a manipulated variable calculation function (a function of calculating a manipulated variable from a desired controlled variable and a controlled variable) of a controller is acquired as a function with a particular characteristic by adjusting control parameters of a control algorithm of a controller, using an interaction process, for example. And with this, by simulating the state when the controller with the adjusted control parameters controls the controlled object, data is created and outputted which shows relationship among a manipulated variable inputted to the controlled-object model, a manipulated variable outputted from the controlled-object model and a desired controlled variable.

As described above, according to the control parameter adjustment method of the present invention, when variously adjusting control parameters of a controller, a worker can immediately know what control can be performed by using a controlled-object model generated by the controlled-object model generation method of the present invention. Accordingly, even a worker who is not familiar with adjustment of control parameters can easily adjust control parameters.

### BRIEF DESCRIPTION OF THE DRAWINGS

FIG. 1 shows an embodiment of the present invention.

FIG. 2 shows an embodiment of a process flow to be executed by a control data collection unit.

FIG. 3 shows an embodiment of a process flow to be executed by a controlled-object model generation unit.

FIG. 4 shows an embodiment of a process flow to be executed by a controller simulation unit.

FIG. 5 is an explanatory diagram of control data to be collected by the control data collection unit.

FIG. 6 is an explanatory diagram of a screen to be displayed by the controlled-object model generation unit.

FIG. 7 is an explanatory diagram of a screen to be displayed by the controlled-object model generation unit.

FIG. 8 is an explanatory diagram of a screen to be displayed by the controller simulation unit.

FIG. 9 is an explanatory diagram of a screen to be displayed by the controller simulation unit.

FIG. 10 shows another embodiment of a process flow to be executed by the controlled-object model generation unit.

### DETAILED DESCRIPTION OF THE PREFERRED EMBODIMENTS

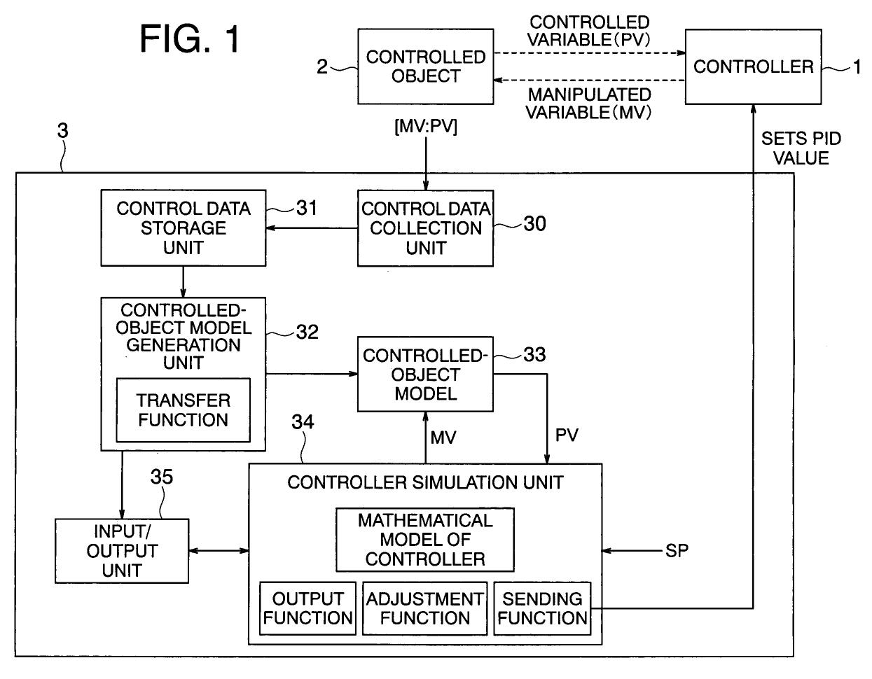

The present invention will be described below in detail according to embodiments. FIG. 1 illustrates an embodiment of the present invention. In FIG. 1, reference numeral 1 denotes a controller for performing PID control, for example. Reference numeral 2 denotes a controlled object such as a furnace. Reference numeral 3 denotes a computer provided with the present invention, for setting control parameters (such as a PID value) of a control algorithm implemented on the controller 1.

The computer 3 provided with a feature of the present invention comprises a portable computer, for example. In order to realize the present invention, the computer 3 comprises the following. A control data collection unit 30 collects control data. A control data storage unit 31 stores the control data collected by the control data collection unit 30. A controlled-object model generation unit 32 generates a controlled-object model 33 to be a model of the controlled object 2 using the control data stored in the control data storage unit 31, on the assumption in advance of a certain transfer function. A controller simulation unit 34 is provided with a function of simulating the control algorithm implemented on the controller 1 (a control algorithm of the controller 1), and determines control parameters to be set on the controller 1 by simulating the control operation performed by the controller 1 with the use of the simulation function and the controlled-object model 33. An input/output unit 35 is provided with a display, a keyboard and the like and performs a step of interaction with a worker.

The control data collection unit 30, the controlled-object model generation unit 32 and the controller simulation unit 34 are constituted with programs, for example.

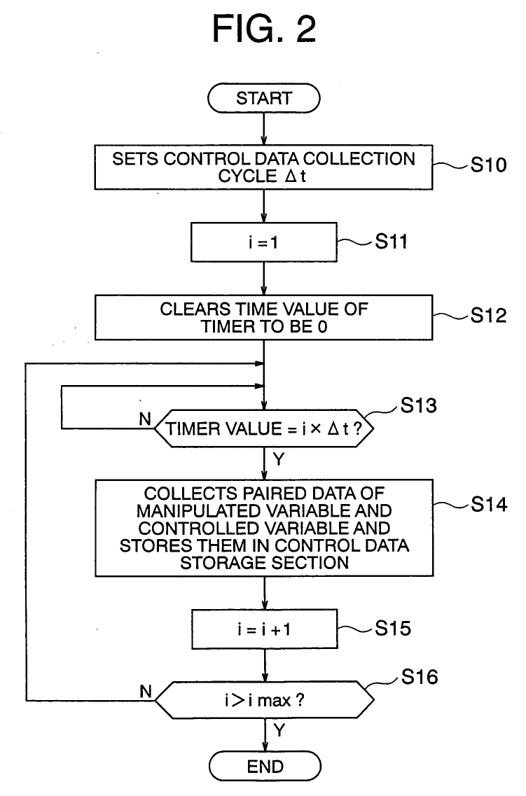

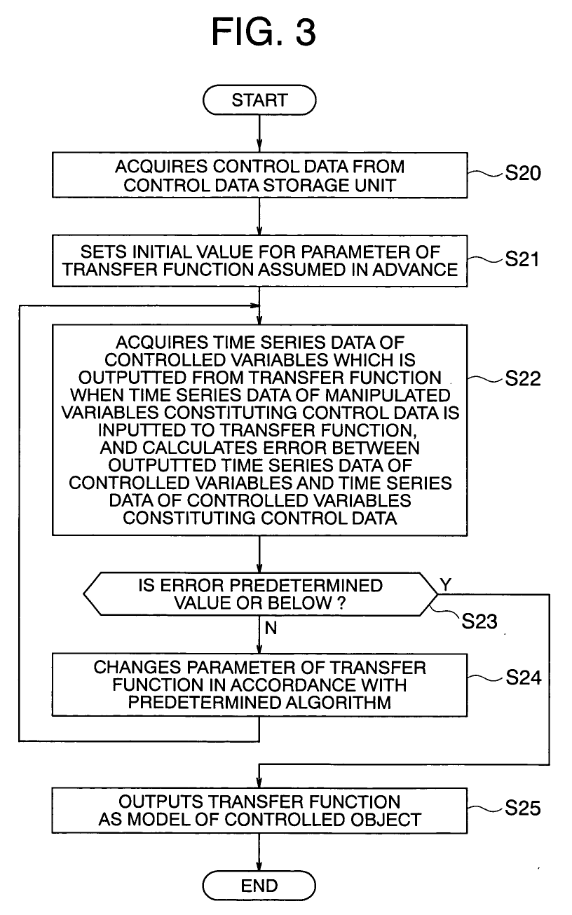

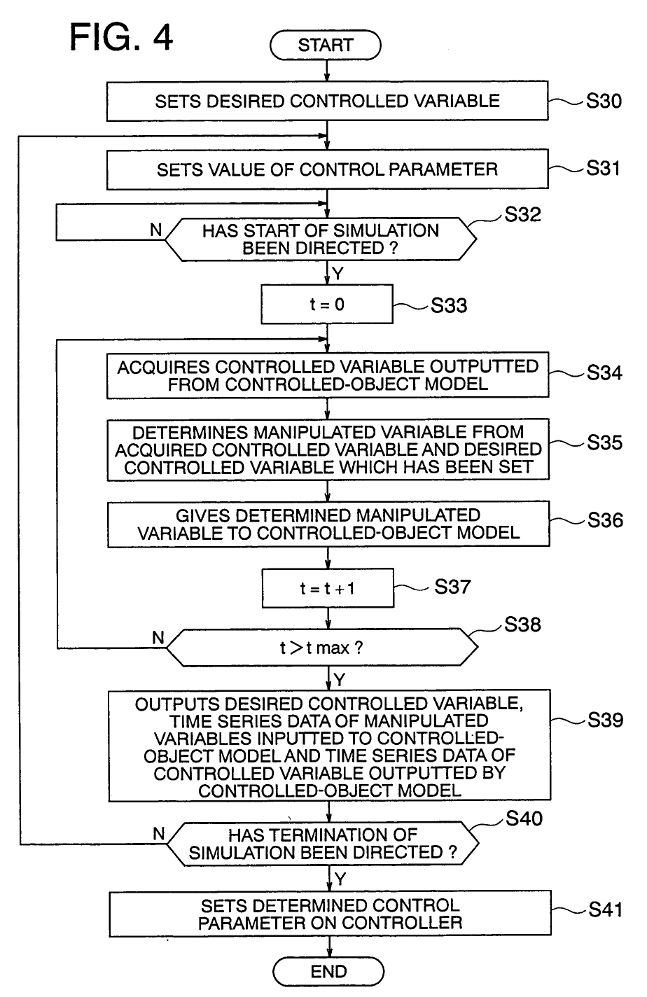

FIG. 2 illustrates an example of a process flow to be executed by the control data collection unit 30. FIG. 3 illustrates an embodiment of a process flow to be executed by the controlled-object model generation unit 32. FIG. 4 illustrates an embodiment of a process flow to be executed by the controller simulation unit 34.

Detailed description will be now made on a process which is executed by the computer 3 provided with the present invention, according to these process flows.

When a request to collect control data is issued from a worker, as shown in the process flow in FIG. 2, the control data collection unit 30 first sets at step S10 a data collection cycle Δt (for example, 1 second), according to an interaction process. Then, at step S11, “1” is set for a variable “i”, and at the following step S12, the time value of a timer is cleared to be “0”.

Then, at step S13, the control data collection unit 30 waits until the time value of the timer reaches “i×Δt”. When it is determined that the time value of the timer has reached “i×Δt”, that is, it is determined that the control data collection cycle has been completed, the process proceeds to step S14. At the step S14, paired data is collected which are made of a manipulated variable given to the controlled object 2 and a controlled variable outputted from the controlled object 2 in response thereto, and is stored in the control data storage unit 31.

In this case, the controlled object 2 may be under the control of the controller 1 or not under the control of the controller 1 (for example, in a state where the controller 1 is set in a manual mode, and a worker sequentially gives an appropriate manipulated variable to the controlled object 2 via the controller 1).

Then, at step S15, the value of the variable “i” is incremented by “1”, and at the following step S16, it is determined whether or not the value of the variable “i” has exceeded the maximum value set in advance. When it is determined that the value has not exceeded the maximum value, the process returns to step S13. When it is determined that the value has exceeded the maximum value, the process is terminated.

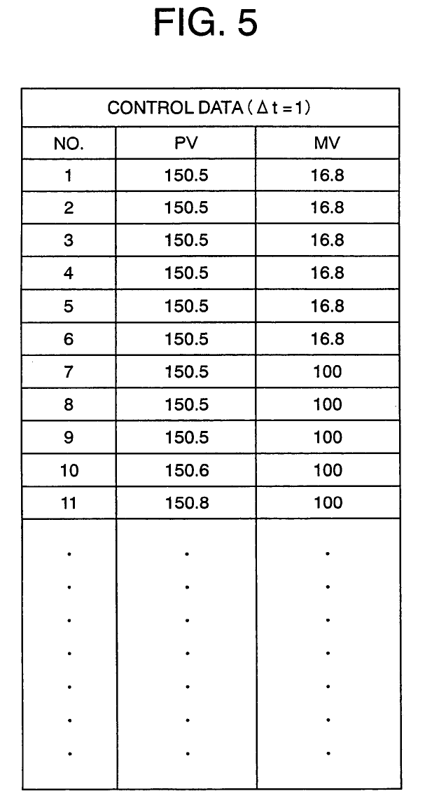

In this way, as shown in FIG. 5, the control data collection unit 30 collects time series data of manipulated variables given to the controlled object 2 and time series data of controlled variables outputted from the controlled object 2 in response thereto, and stores them in the control data storage unit 31.

Next, a process which is executed by the controlled-object model generation unit 32 will be described.

The controlled-object model generation unit 32 generates a controlled-object model 33, which is to be a model of the controlled object 2, using the control data stored in the control data storage unit 31, on the assumption in advance of a certain transfer function.

As the transfer function assumed in this case, a formula shown below (which may be hereinafter referred to as a formula #1) having a transfer characteristic of “primary delay+dead time” can be used, for example.

$$G ( s ) = \frac{Kp \cdot {ⅇ}^{- Lp \cdot s}}{( 1 + {T}_{1} \cdot S )} \qquad ( Formula \#1 )$$

In the above formula, Kp indicates gain; Lp indicates dead time; and T₁ indicates a time constant.

In this case, when “x=(Kp, T₁, Lp)” is assumed, a controlled variable PVm(x) outputted by the transfer function is as follows:
PVm(x)=G(x)·MV+PV_{offset}

When a request to generate a controlled-object model 33 is issued from a worker, as shown in the process flow of FIG. 3, the controlled-object model generation unit 32 first acquires the control data stored in the control data storage unit 31 at step S20, and sets an appropriate initial value for the parameter x of the transfer function assumed in advance at the following S21. For example, a value randomly generated is set as an initial value.

Then, at step S22, by inputting time series data of manipulated variables constituting the acquired control data to the transfer function, the controlled-object model 33 acquires time series data of controlled variables outputted from the transfer function. And then, the controlled-object model 33 calculates an error between the time series data of control variables acquired as described above and the time series data of control variables constituting the acquired control data.

For example, the error is calculated by calculating the sum of absolute differences between the control variables of the two kinds and then calculating the average value thereof, according to a calculation expression shown below (which may be hereinafter to as a formula #2).

$$E ( x ) = \frac{1}{n} \cdot {\sum }_{i = 1}^{n} \vert {PV}_{i} - {PVm}_{i} ( x ) \vert \qquad ( Formula \#2 )$$

In the above formula, PVᵢ denotes the i-th controlled variable; PVmᵢ(x) denotes the i-th output value; and “n” denotes the number of time series data.

The error is calculated according to the formula #2 here. However, it is needless to say that a different calculation expression may be used, such as an calculation expression for calculating a square sum, rather than the calculation expression for calculating an average value.

Then, at step S23, it is determined whether or not the calculated error is a predetermined value or below. When it is determined that the error is not the predetermined value or below, then the process proceeds to step S24. At the step S24, a parameter “x” of the transfer function is calculated which causes the error described above to gradually diminish, for example, according to the optimum solution search algorithm of Powell's method. The parameter x is changed based thereon, and the process returns to step S22.

The process from step S22 to step S24 is repeated. And, when it is determined at step S23 that the above-mentioned error is the predetermined value or below, then it is determined that identification of the parameter of the transfer function has been completed. The process then proceeds to step S25. At the step S25, the transfer function having the identified parameter is outputted as a model of the controlled object 2, and then generation of the controlled-object model 33 is terminated.

As described above, the controlled-object model generation unit 32 assumes a certain transfer function in advance, identifies a parameter of the transfer function with the use of the control data stored in the control data storage unit 31, according to the optimum solution search algorithm of Powell's method, for example, and generates a controlled-object model 33 which is to be a model of the controlled object 2.

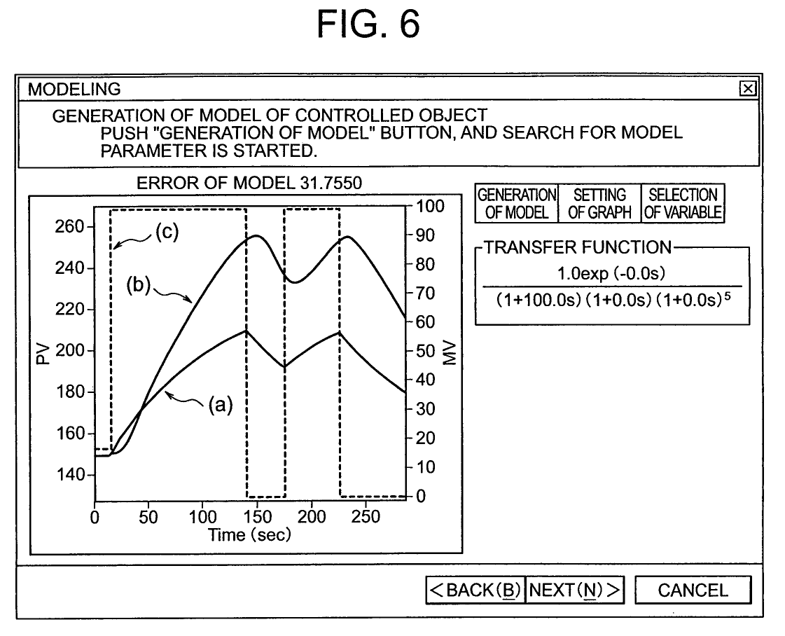

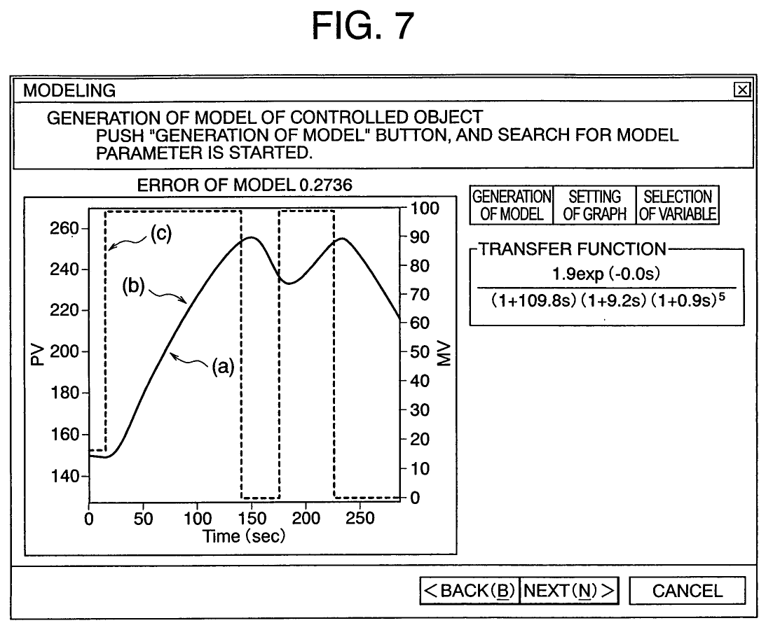

Then, as shown in FIG. 6, there is significant difference between the time series data of controlled variables outputted from the transfer function ((a) in FIG. 6) and the time series data of controlled variables acquired from the control data storage unit 31 ((b) in FIG. 6), when the step of identifying a parameter of the transfer function is started. But, both time series data almost correspond to each other, when the identification process is completed, as shown in FIG. 7. Thereby, it is possible to generate a controlled-object model 33 for realizing high-accuracy modeling.

The display screens shown in FIGS. 6 and 7 are displayed by the controlled-object model generation unit 32 on a display of the input/output unit 35 for notification to a worker, and (c) shown in FIGS. 6 and 7 indicates time series data of manipulated variables inputted to a transfer function.

Next, description will be made on a process which is executed by the controller simulation unit 34.

When a request to set a control parameter on the controller 1 is issued from a worker, as shown in the process flow in FIG. 4, the controller simulation unit 34 first sets a desired controlled variable (SP) at step S30, for example, according to an interaction process.

Then, at step S31, the controller simulation unit 34 sets a value of a control parameter of the control algorithm implemented on the controller 1 (a value on the control algorithm of the controller 1), for example, according to an interaction process. When the control parameter of the control algorithm implemented on the controller 1 is a PID, the value of a PID is set.

Then, at step S32, the controller simulation unit 34 waits until a direction to start simulation is issued from the worker. When the direction to start simulation is issued, then the process proceeds to step S33, where “0” is set for a variable “t” indicating elapsed time.

Then, at step S34, the controller simulation unit 34 acquires a controlled variable (PV) outputted from the controlled-object model 33. And, at the following step S35, the controller simulation unit 34 determines a manipulated variable (MV) by simulating the control algorithm implemented on the controller 1 from the acquired controlled variable and the desired controlled variable which has been set.

Then, at step S36, the determined manipulated variable is given (inputted) to the controlled-object model 33. Then, at step S37, the value of the variable “t” is incremented by “1”, and at the following S38, it is determined whether or not the value of the variable “t” has exceeded the maximum value set in advance.

When it is determined, according to the above determination process, that the value of the variable “t” has not exceeded the maximum value, then the process returns to step S34. When it is determined that the value of the variable “t” has exceeded the maximum value, then the process proceeds to step S39. At the step S39, the controller simulation unit 34 outputs to a display of the input/output unit 35 the desired controlled variable which has been set, the time series data of manipulated variables inputted to the controlled-object model 33, and the time series data of controlled variables outputted from the controlled-object model 33 in response to the input of the controlled variables.

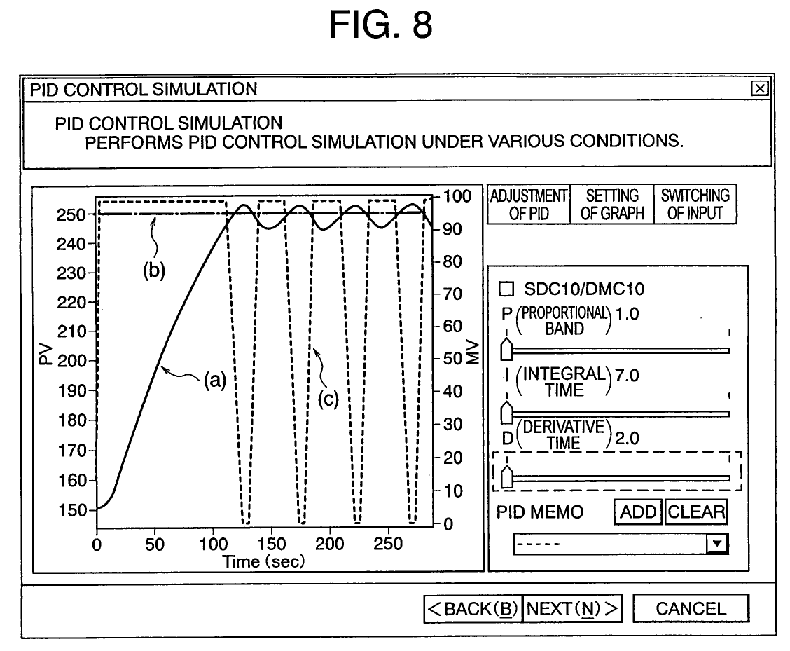

For example, as shown in FIG. 8, the display of the input/output unit 35 is outputted the desired controlled variable which has been set ((b) in FIG. 8), the time series data of manipulated variables inputted to the controlled-object model 33 ((c) in FIG. 8), and the time series data of controlled variables outputted from the controlled-object model 33 in response to the input of the manipulated variables ((a) in FIG. 8).

FIG. 8 shows control state data in a case that values of the control parameters are set as “P=1.0, I=7.0, D=2.0”.

Then, at step S40, it is determined whether or not a direction to terminate the simulation has been issued from the worker.

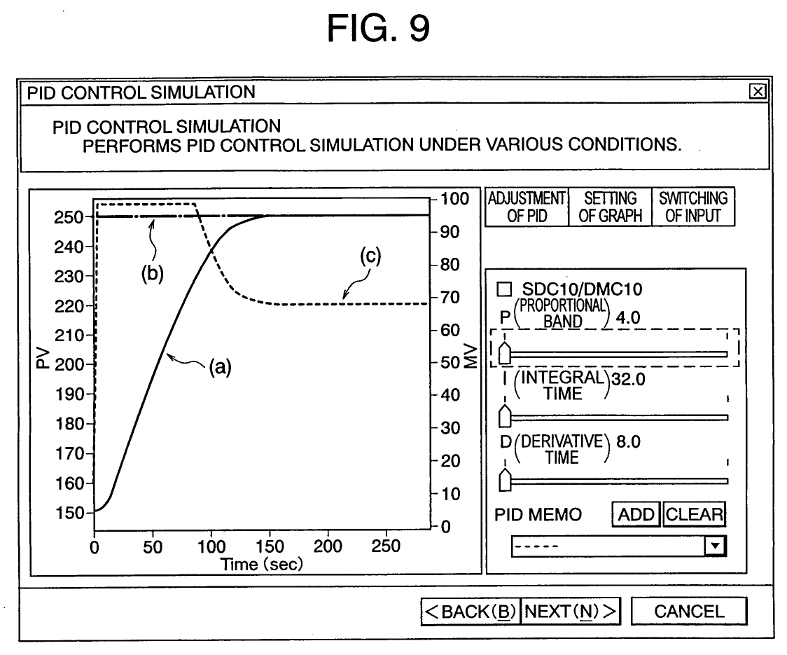

When the control parameter set at step S31 becomes appropriate, or when the output data outputted to the display at step S39 indicates a favorable control state, for example, as shown in FIG. 9, the worker issues a direction to terminate the simulation. Therefore, at step S40, it is determined whether or not the worker has issued a direction to terminate the simulation in response to the output data outputted to the display.

FIG. 9 shows control state data in a case that values of the control parameters are set as “P=4.0, I=32.0, D=8.0”.

When it is determined at step S40 that a direction to terminate the simulation has not been issued, the process returns to step S31 to perform processing for a new control parameter. When it is determined that a direction to terminate the simulation has been issued, the process proceeds to step S41. At the step S41, it is decided that the finally set control parameter is the control parameter to be set on the controller 1, and the parameter is set on the controller 1, and then the process is terminated.

As described above, the controller simulation unit 34 simulates the control operation executed by the controller 1 using the controlled-object model 33, determines a control parameter to be set on the controller 1 by presenting the control operation to the worker, and sets the control parameter on the controller 1.

In the embodiment described above, a feature is used in which one transfer function (for example, a transfer function having the transfer characteristic of the above-mentioned formula #1) is assumed as a transfer function to be a generation source of a controlled-object model 33. However, it is possible to use a feature in which a plurality of transfer functions are assumed and the most appropriate transfer function is selected therefrom.

For example, it is possible to use a feature in which a formula having a transfer characteristic of “secondary delay+dead time” (formula #3) and a formula having a transfer characteristic of “integral+dead time” (formula #4) are assumed as transfer functions to be generation sources of a controlled-object model 33 in addition to the transfer function having the transfer characteristic of the formula #1 described above, and the most appropriate transfer function is selected therefrom.

$$\begin{matrix}G ( s ) = \frac{Kp \cdot {ⅇ}^{- Lp \cdot s}}{{s}^{2} + 2 {ξω}_{n} s + {{ω}_{n}}^{2}} & ( Formula \#3 ) \\ G ( s ) = \frac{Kp \cdot {ⅇ}^{- Lp \cdot s}}{s} & ( Formula \#4 )\end{matrix}$$

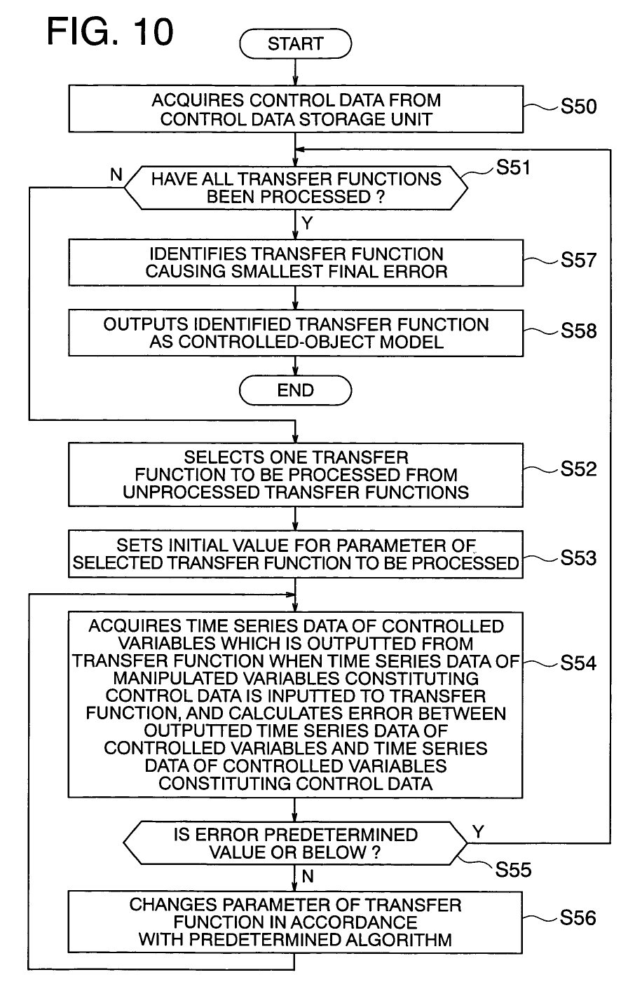

When this feature is used, the controlled-object model generation unit 32 generates a controlled-object model according to the process flow shown in FIG. 10.

That is, in a case that this feature is used, when a request to generate a the controlled-object model 33 is issued from a worker, as shown in the process flow of FIG. 10, the controlled-object model generation unit 32 first acquires the control data stored in the control data storage unit 31 at step S50.

Then, at step S51, it is determined at step S51 whether or not all the transfer functions assumed in advance have been processed. When it is determined that there remain unprocessed transfer functions, then the process proceeds to step S52, where one transfer function to be processed is selected from the unprocessed transfer functions. At the following step S53, a suitable initial value is set for the parameter “x” of the selected transfer function.

Then, at step S54, the controlled-object model generation unit 32 inputs time series data of manipulated variables constituting the acquired control data to the selected transfer function, and acquires time series data of controlled variables which is outputted from the selected transfer function. And, the controlled-object model generation unit 32 calculates the error between the time series data of controlled variables acquired as described above and the time series data of controlled variables constituting the acquired control data, according to the above-mentioned formula #2, for example.

Then, at step S55, it is determined whether or not the calculated error is a predetermined value or below. When it is determined that the error is not the predetermined value or below, then the process proceeds to step S56. At the step S56, a parameter “x” of the transfer function is calculated which causes the error described above to gradually diminish, for example, according to the optimum solution search algorithm of Powell's method. The parameter “x” is changed based thereon, and the process returns to step S54.

The process from step S54 to step S56 is repeated, and when it is determined at step S55 that the above-mentioned error is the predetermined value or below, the process returns to step S51 to start processing the next transfer function.

Then, the process from S51 to S56 is repeated, and when it is determined at step S51 that all the transfer functions assumed in advance have been processed, then the process proceeds to step S57. At the step S57, the final errors acquired for respective transfer functions at step S54 is compared, and a transfer function is identified which causes the smallest final error. At the following S58, the identified transfer function is outputted as a model of the controlled object 2, and the generation of the controlled-object model 33 is completed.

As described above, in the case of following the process flow in FIG. 10, the controller simulation unit 34 generates a controlled-object model 33 for realizing high-accuracy modeling by assuming a plurality of transfer functions as generation sources of the controlled-object model 33 and by selecting the most appropriate transfer function therefrom.

As has been described above, according to the controlled-object model generation method of the present invention, it is possible to automatically generate a model of a controlled object without any specialized consideration or works being required only when time series data of manipulated variables given to the controlled object and time series data of controlled variables outputted from the controlled object in response thereto can be acquired.

Furthermore, according to the controlled-object model generation method of the present invention, it is possible to automatically generate a controlled-object model for realizing higher-accuracy modeling by assuming a plurality of transfer functions.

Furthermore, according to the control parameter adjustment method of the present invention, when variously adjusting control parameters of a controller, a worker can immediately know what control can be performed by using a controlled-object model generated by the controlled-object model generation method of the present invention. Accordingly, even a worker who is not familiar with adjustment of control parameters can easily adjust control parameters.

What is claimed is:

1. A controlled-object model generation method for generating a model of a controlled object, the method comprising the steps of:
acquiring time series data of manipulated variables given to a controlled object and time series data of controlled variables outputted by the controlled object in response thereto; and
generating a model of the controlled object by acquiring time series data of values which is outputted from a transfer function assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum.

2. A controlled-object model generation program used for realization of a controlled-object model generation method, the program causing a computer to execute the steps of:
acquiring time series data of manipulated variables given to a controlled object and time series data of controlled variables outputted by the controlled object in response thereto; and
generating a model of the controlled object by acquiring time series data of values which is outputted from a transfer function assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum.

3. A controlled-object model generation method for generating a model of a controlled object, the method comprising the steps of:
acquiring time series data of manipulated variables given to a controlled object and time series data of controlled variables outputted by the controlled object in response thereto;
acquiring time series data of values which is outputted from each of transfer functions assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum; and
selecting, from the plurality of transfer functions having the identified parameters, the optimum one as a model of a controlled object based on the error acquired when the identification is completed or the value derived from the error.

4. A controlled-object model generation program used for realization of a controlled-object model generation method, the program causing a computer to execute the steps of:
acquiring time series data of manipulated variables given to a controlled object and time series data of controlled variables outputted by the controlled object in response thereto;
acquiring time series data of values which is outputted from each of transfer functions assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum; and
selecting, from the plurality of transfer functions having the identified parameters, the optimum one as a model of a controlled object based on the error acquired when the identification is completed or the value derived from the error.

5. A control parameter adjustment method for adjusting control parameters of a controller, the method comprising the steps of:
generating a model of a controlled object according to a controlled-object model generation process for generating a model of a controlled object;
in order to adjust a control algorithm of the controller, adjusting control parameters of the control algorithm; and
creating and outputting data showing relationship among a desired controlled variable, a manipulated variable and a controlled variable by simulating the state when the controller with the adjusted control parameters controls the controlled object with the use of the controlled-object model and the control algorithm,
wherein the predetermined controlled-object model generation process further comprises:
acquiring time series data of manipulated variables given to a controlled object and time series data of controlled variables outputted by the controlled object in response thereto; and
generating a model of the controlled object by acquiring time series data of values which is outputted from a transfer function assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum.

6. A control parameter adjustment program used for realization of a control parameter adjustment method, the program causing a computer to execute the steps of:
acquiring time series data of manipulated variables given to a controlled object and time series data of controlled variables outputted by the controlled object in response thereto;
generating a model of the controlled object by acquiring time series data of values which is outputted from a transfer function assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum;
in order to adjust a control algorithm of the controller, adjusting control parameters of the control algorithm; and
creating and outputting data showing relationship among a desired controlled variable, a manipulated variable and a controlled variable by simulating the state when the controller with the adjusted control parameters controls the controlled object with the use of the controlled-object model and the control algorithm.

7. A control parameter adjustment method for adjusting control parameters of a controller, the method comprising the steps of:
generating a model of a controlled object according to a controlled-object model generation process for generating a model of a controlled object;
in order to adjust a control algorithm of the controller, adjusting control parameters of the control algorithm; and
creating and outputting data showing relationship among a desired controlled variable, a manipulated variable and a controlled variable by simulating the state when the controller with the adjusted control parameters controls the controlled object with the use of the controlled-object model and the control algorithm,
wherein the controlled-object model generation process further comprises:
acquiring time series data of manipulated variables given to a controlled object and time series data of controlled variables outputted by the controlled object in response thereto;
acquiring time series data of values which is outputted from each of transfer functions assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum; and
selecting, from the plurality of transfer functions having the identified parameters, the optimum one as a model of a controlled object based on the error acquired when the identification is completed or the value derived from the error.

8. A control parameter adjustment program used for realization of a control parameter adjustment method, the program causing a computer to execute the steps of:
acquiring time series data of manipulated variables given to a controlled object and time series data of controlled variables outputted by the controlled object in response thereto;
acquiring time series data of values which is outputted from each of transfer functions assumed in advance when the acquired time series data of manipulated variables is inputted to the transfer function, and identifying one or more parameters of the transfer function so that an error between the time series data of output values and the acquired time series data of controlled variables corresponding thereto or a value derived from the error becomes optimum;
selecting, from the plurality of transfer functions having the identified parameters, the optimum one as a model of a controlled object based on the error acquired when the identification is completed or the value derived from the error;
in order to adjust a control algorithm of the controller, adjusting control parameters of the control algorithm; and
creating and outputting data showing relationship among a desired controlled variable, a manipulated variable and a controlled variable by simulating the state when the controller with the adjusted control parameters controls the controlled object with the use of the controlled-object model and the control algorithm.
